(19) United States
(12) Patent Application Publication
(10) Pub. No.: US 2003/0050216 A1
(43) Pub. Date: Mar. 13, 2003

(54) Detergent composition in tablet form

(75) Inventors: Paul William Robinson, North Ferriby (GB); Guido Waeschenbach, Oakland, NJ (US); Brendan Collins, Wiesbaden (DE); Ralf Wiedemann, Griesheim (DE); Enric Carbonell, Barcelona (ES); Richard Neergaard, Brussels (BE)

Correspondence Address: AKIN GUMP STRAUSS HAUER & FELD L.L.P., ONE COMMERCE SQUARE, 2005 MARKET STREET, SUITE 2200, PHILADELPHIA, PA, 19103-7013, US

(73) Assignee: Reckitt Benckiser N.V.

(21) Appl. No.: 10/216,529

(22) Filed: Aug. 9, 2002

Related U.S. Application Data
(63) Continuation of application No. PCT/GB01/00510, filed on Feb. 9, 2001.

(30) Foreign Application Priority Data
Feb. 9, 2000 (DE) 100 05 575.3

(51) Int. Cl. C11D 17/00

(52) U.S. Cl. 510/447; 510/446

(57) ABSTRACT

A detergent composition is provided in tablet form which contains at least two types of tablets having different compositions, in which at least one tablet type is manufactured by a process in which substantially no pressure is applied.

### CROSS-REFERENCE TO RELATED APPLICATIONS

This application is a continuation of International Application No. PCT/GB01/00510, filed Feb. 9, 2001, which was published in the English language on Aug. 16, 2001, under International Publication No. WO 01/59056 and the disclosure of which is incorporated herein by reference.

### BACKGROUND OF THE INVENTION

The present invention relates to a detergent composition in tablet form consisting of a combination of at least two types of tablets with different compositions, a process for manufacturing the composition, and its uses.

Detergent compositions, such as detergents for dish-washing machines and for laundry washing machines, are nowadays available in three different presentations.

The traditional presentation, which is still the most common even today in laundry detergents, for example, consists of powder or granules in which the average particle size ranges from about 0.1 to about 2 mm in diameter. It is standard for powder or granules, both in a dishwasher and in a washing machine, to be washed out of an appropriate chamber by water, in which the chamber opens during the washing cycle. Because of the hygroscopic nature of the powder or granules, lumps occasionally form, so that the amount of detergent used may be too small. Therefore, certain ingredients such as paraffin have been added to the detergent composition to prevent the formation of such lumps, but such a method may not be successful in all cases.

A second presentation is liquid detergents, though their cleaning power does not match that of conventional powders or granules.

For some years now, detergents in tablet form have been available on the market and, in the case of dishwasher detergents, for example, they have in the meantime actually overtaken the other types. These tablets are usually manufactured from the same ingredients as the known powders or granules, sometimes with the addition of tabletting aids. The problems with the formation of lumps which were known from powders and granules cannot occur with these tablets, which usually contain the full amount needed for one washing cycle, so that in each case, only one (or a small number of) tablet(s) need(s) to be used for each washing cycle. Furthermore, the use of detergent tablets avoids the need to measure out powder or granules, which can sometimes be complicated and tiresome. There is admittedly one disadvantage compared to the use of powder or granules, namely the reduced flexibility in measuring out the required quantity, since it is usual for the same amount of detergent to be added to every washing cycle, which is determined by the size of the tablet, irrespective of whether the crockery or laundry is heavily or lightly soiled and whether the machine is being operated with a full or reduced load.

A dishwasher detergent in tablet form is known from European Patent EP 0 318 204 A1, which consists of a combination of at least two types of tablets in which incompatible components are distributed among these tablet types in such a way that substantially no incompatible ingredients are formulated in the same tablet type. In a preferred embodiment of the invention, one tablet type contains builders and enzyme(s), for example, whereas the second tablet type contains silicate and bleach. In this case, the tablets of each tablet type are usually smaller than conventional tablets, since the different ingredients are distributed between two tablet types. The weight is stated to be 0.2 to 40 g, preferably 0.5 to 5 g per tablet. In each case, all the tablet types are manufactured by pressing.

### BRIEF SUMMARY OF THE INVENTION

The present invention is based on the problem of improving the detergent composition known from the state of the art in such a way that greater flexibility in the choice of components for the different types of tablet becomes possible. According to the present invention, a detergent composition in tablet form is provided which comprises at least a first tablet type and a second tablet type, the first tablet type having a different composition from the second tablet type, wherein at least the first tablet type comprises substantially non-compacted starting material. A process for manufacturing the detergent composition is also provided, which comprises manufacturing at least one tablet type using a process in which substantially no pressure is applied, manufacturing at least a second tablet type using a process in which pressure is applied, and mixing the at least two tablet types to form a mixture comprising various ingredients for a washing application.

### DETAILED DESCRIPTION OF THE INVENTION

The problems in the prior art are solved by the detergent composition according to the invention which comprises at least a first and a second type of tablet having different compositions, in which at least one tablet type is manufactured by a process in which no or substantially no pressure is applied in the process of manufacture, i.e., the starting materials are non-compressed or substantially non-compressed. In a preferred embodiment, the tablet type which is manufactured using a process in which no or substantially no pressure is applied contains at least one surfactant, enzyme, and/or polymer.

According to the present invention, the detergent composition in tablet form preferably contains at least a second type of tablet manufactured using a process in which pressure is applied, i.e., the starting materials are compressed together. This second tablet type preferably contains at least one of the following ingredients: builders, surfactants, bleaches, bleach activators, enzymes and buffer substances.

Before turning to a detailed description of the composition of the invention, it should first of all be pointed out that the terms “detergent composition” and “detergent” are understood in a broad sense in the present application, namely as comprising all those substances and mixtures of substances which can be used in connection with cleaning processes. These include not only the compositions which are actually active in cleaning, such as dishwasher detergents and washing substances, but also compositions which support the cleaning functions concerned, such as water softeners, or which have the effect of providing protective care, such as fabric softeners or final rinses.

Preferably, each tablet according to the present invention weighs less than about 600 mg, more preferably less than about 400 mg, and most preferably less than about 250 mg. It is further preferred if each tablet weighs more than about 10 mg, more preferably more than about 20 mg and most preferably more than about 40 mg. In a preferred embodiment, the tablets according to the invention weigh about 5 to about 700 mg, and more preferably about 50 to about 150 mg.

The invention further is directed to a process for manufacturing the detergent composition. The process comprises manufacturing at least one tablet type using a process in which substantially no pressure is applied, manufacturing at least a second tablet type using a process in which pressure is applied, and mixing the at least two tablet types to form a mixture comprising various ingredients for a washing application.

Preferable processes in which no or substantially no pressure is applied are processes including granulation, extrusion, casting and injection molding. Casting may include hot casting using ingredients having a relatively low melting point, such as PEG 6000 or pre-determined ratios of palmitic and stearic acid, or cold casting using freeze dry techniques (lyophilisation). Suitable solvents for freeze drying include water as well as volatile solvents, such as isopropanol or ethanol.

Preferable processes in which pressure is applied are processes such as pressing or compacting.

The detergent composition of the invention may be used in a variety of ways in appropriate (i.e., effective) quantities, e.g., as a dishwasher detergent, in the final rinse in a dishwasher, as a detergent in a washing machine, as a detergent for hand-washing laundry, as a water softener or fabric conditioner in a washing machine, as a bleach enhancer in a washing machine or dishwasher, or as a descaling agent. It goes without saying that other possible uses are conceivable and are also encompassed.

The detergent composition of the invention is superior to those of the state of the art especially because the possibility of formulating the individual tablet types using different processes allows greater flexibility with regard to the choice of components. In particular, components which are not suitable for processing by processes in which pressure is applied because they decompose under these conditions, for example, or because they are damaged in other ways, can be formulated in tablet types that are manufactured by means of processes in which no or substantially no pressure is applied, such as granulation, extrusion, casting, etc. Other components which are less sensitive in this respect may still be formed into tablets with no difficulty using processes in which pressure is applied, such as pressing, compacting, etc.

As already described in the prior art cited, the tablets may, after manufacture, be sold to the consumer in a variety of ways. The different tablet types may, for example, be pre-mixed in such a way that the mixture contains the individual ingredients in a composition suitable for the respective use intended. Another possibility involves packing the different tablet types separately, so that the consumer has to mix them in the ratios specified (building block system).

In addition, the preferred embodiment of the invention, in which each individual tablet weighs about 5 to about 700 mg, and particularly preferably about 50 to about 150 mg, possesses a wide range of advantages both over conventional powders and granules and over conventional tablets.

The presentation in the form of tablets, which are preferably manufactured by pressing or compacting, can make a substantial reduction possible in the amount of dust formed in the case of powders and granules, both in manufacturing and packaging, and in use. In contrast to powders and granules, the small tablets of the invention tend less to coagulate, both in storage and in the machine chamber (especially when predissolved therein), since they are less sensitive to moisture. With the tablet form of the detergent composition of the invention, it is also possible to have better control over solubility, for example, by providing components or a coating which delays dissolution, or by pressing or compacting under high pressure.

As a result of the fact that the tablets of the invention are larger than conventional powders or granules, they are not completely removed from the machine during the pumping stage after the main washing stage or the intermediate rinsing stages, so that ingredients may be included which are not intended to develop their effect until the final rinsing stage.

A further problem with powders and granules, namely the separation of fine particles that inevitably occurs during manufacture which prevents the uniform distribution of ingredients, can likewise be avoided by using the composition of the invention. Finally, there is also greater flexibility with regard to the choice of components, because components can also be included which are not readily miscible into powders or granules—substances with a certain stickiness, for example, such as surfactants.

Compared to conventional detergent tablets, the composition of the invention can be metered more flexibly, flexibility which is not in principle inferior to the flexibility of powders and granules. In order to manufacture the small tablets of the composition of the invention, it is also possible to use procedures other than conventional tabletting, such as compacting, which is also understood to include agglomeration under pressure without the use of binders. Therefore, there is also greater flexibility with regard to the manufacturing process.

Since the small tablets according to the present invention have a larger surface area than conventional large tablets, it is possible to spray on more material or to apply it by means of other coating methods. Because of their higher surface-to-volume ratio, the tablets of the detergent composition of the invention are more rapidly soluble than conventional detergent tablets, e.g. even in water at lower temperatures, such as for hand-washing detergents. For this reason, it is also possible to include more poorly soluble substances (especially such as surfactants), optionally employing an effervescent system in order to enhance solubility still further.

In the case of perfume substances which are conventionally added to detergent compositions, the fact that they are worked into the tablets leads to better retention than in the case of powders and granules, and secondly the larger surface area allows the perfume to develop a better effect in the washing process than in the case of conventional tablets.

Because of the smaller dimensions of the tablets of the invention, better use can be made of the space available during storage and packaging than with conventional tablets. Furthermore, the smaller tablets are less susceptible to breakage and can be more easily removed from the machine chamber and distributed in the machine. The problem which occasionally occurs with dishwasher detergent tablets, namely that the tablets become stuck between pieces of crockery and do not dissolve correctly as a result, is likewise reliably avoided.

The starting material for manufacturing the different tablet types may preferably be formulated by combining those ingredients which are not suitable for processing under pressure, so that they can be gently shaped into tablets. The remaining ingredients may be processed using standard tabletting processes.

Typical ingredients that should be used in processes in which no or substantially pressure is applied are surfactants, enzymes and polymers.

Other ingredients, which will not usually suffer from being processed under pressure, are, for example, sources of alkalinity, builders, bleaches, bleach activators, enzymes and buffer substances.

The tablets may have various shapes, such as spherical, cylindrical, ellipsoid, etc. In the case of a spherical design, the preferred diameter is about 2 mm to about 10 mm.

The detergent composition of the invention may be used in a variety of ways, including as a dishwasher detergent, as a final rinse in dishwashers, as a detergent in a washing machine or for a hand wash, as a water softener or fabric softening rinse in a washing machine, as a bleach enhancer, or as a descaling agent. Other fields of use in the detergent sector are conceivable and possible, such as use as a detergent composition for dissolution in water for cleaning hard surfaces, such as floors. The composition may thus contain appropriate (i.e., effective for the purpose) dosages of dishwashing detergent, laundry detergent, water softener, fabric conditioner, bleach enhancer or descaling agent, for example, depending on the desired washing application.

The features of the invention disclosed in the above description and in the claims can be essential, both alone and in any combination, for carrying out the invention in its various embodiments.

The invention will now be described with reference to the following examples.

### EXAMPLE 1

Water Softening Tablets
Single layer and double layer briquettes were produced
Size of tablettinos: Weight = 100 mg
Water softener tab formula (% w/w)

| Ingredients | Total | White Layer | Blue Layer |
|---|---|---|---|
| citrate | 56.120 | 52.730 | 62.890 |
| polymer | 22.770 | 22.770 | 22.770 |
| PEG 6000 | 3.000 | 3.000 | 3.000 |
| cellulose | 4.500 | 4.500 | 4.500 |
| cellulose | 2.500 | 2.500 | 2.500 |
| sulfate | 8.350 | 12.520 | 0.000 |
| silicate | 0.660 | | 2.000 |
| Dye | 0.005 | | 0.016 |
| PEG 200 | 0.115 | | 0.344 |
| Water | 1.980 | 1.980 | 1.980 |
| Total | 100.000 | 100.000 | 100.000 |

Manufacturing Instructions:

White Powder Mixture

Add the raw materials to the Lödige Mixer in the above order while the mixer works at 20% speed. Mix for 30 seconds with mixer at 50% speed and check versus specification. Protect from heat and humidity.

Blue Powder Mixture

Add raw materials 1 to 6 to the Ruberg Mixer in the above order while mixing at 50% speed.

Spray on the color pre mix over 1 minute while continuing to mix.

Remove the fuel injector, then mix for 3 minutes at 50% speed. The color should appear homogeneous.

Check the specifications data and fill in two big bags, close and protect against heat and humidity. Process the mix within 4 weeks max.

Color Pre Mix

| Ingredients | % (w/w) |
|---|---|
| Polyethylene Glycol 200 | 95.667 |
| dye | 4.333 |

Mixer must be dry. Add the ingredients. Mix for 5 minutes. The liquid should appear homogeneous. Store in closed containers.

In a process of cold casting, the above mixtures were poured into a mold and freeze dried to result in a tablet of sufficient robustness. The tablets so produced may then be mixed with other tablets manufactured by conventional pressing or compaction techniques.

### EXAMPLE 2

Double layer(divided hopper) tablettinos were produced

Size of tablettinos:

Length=9 mm

Width=6 mm

Thickness=4.35 mm

Weight=0.27 g

Formula: double layer briquettes (% weight/weight)

| Layers | NaCl | Organic Acid | PEG 600 | Dye |
|---|---|---|---|---|
| White | 96 | 0 | 4 | 0 |
| Blue | 88.725 | 7.2 | 4 | 0.075 |
| White | 96 | 0 | 4 | 0 |
| Blue | 98.7 | 7.2 | 4 | 0.1 |
| White | 96 | 0 | 4 | 0 |
| Blue | 88.775 | 7.2 | 4 | 0.025 |
| White | 96 | 0 | 4 | 0 |
| Blue | 88.76 | 7.2 | 4 | 0.04 |
| White | 96 | 0 | 4 | 0 |
| Blue | 88.79 | 7.2 | 4 | 0.01 |
| White | 96 | 0 | 4 | 0 |
| Blue | 88.75 | 7.2 | 4 | 0.05 |

The polyethylene glycol 6000 has a wax-like consistency and a melting temperature of less than 40° C. The mixtures above therefore exhibit flowability at approximately 40 to 50° C. At this temperature, the above mixtures are cast into molds and cooled to their final shape in a process of hot casting.

An alternative embodiment would be to replace or augment the PEG 6000 with a pre-determined ratio of palmitic and stearic acid, which would again result in a lowered flowability temperature for the mixtures above, thereby allowing hot casting.

It will be appreciated by those skilled in the art that changes could be made to the embodiments described above without departing from the broad inventive concept thereof. It is understood, therefore, that this invention is not limited to the particular embodiments disclosed, but it is intended to cover modifications within the spirit and scope of the present invention as defined by the appended claims.

We claim:

1. A detergent composition in tablet form comprising at least a first tablet type and a second tablet type, the first tablet type having a different composition from the second tablet type, wherein at least the first tablet type comprises substantially non-compressed starting materials.

2. The detergent composition according to claim 1, wherein at least the first tablet type comprises at least one ingredient selected from the group consisting of a surfactant, an enzyme and a polymer.

3. The detergent composition according to claim 1, wherein at least the second tablet type comprises compressed starting materials.

4. The detergent composition according to claim 3, wherein at least the second tablet type comprises at least one ingredient selected from the group consisting of a source of alkalinity, a builder, a surfactant, a bleach, a bleach activator, an enzyme and a buffer substance.

5. The detergent composition according to claim 1, wherein the first and the second tablets weigh about 5 to about 700 mg.

6. The detergent composition according to claim 5, wherein the first and the second tablets weigh about 50 to about 150 mg.

7. The detergent composition as in claim 1, wherein the composition contains an appropriate dosage of a dishwasher detergent.

8. The detergent composition as in claim 1, wherein the composition contains an appropriate dosage of a dishwasher final rinse detergent.

9. The detergent composition as in claim 1, wherein the composition contains an appropriate dosage of a washing machine laundry detergent.

10. The detergent composition as in claim 1, wherein the composition contains an appropriate dosage of a hand-washing laundry detergent.

11. The detergent composition as in claim 1, wherein the composition contains an appropriate dosage of a washing machine water softener.

12. The detergent composition as in claim 1, wherein the composition contains an appropriate dosage of a washing machine fabric conditioner.

13. The detergent composition as in claim 1, wherein the composition contains an appropriate dosage of a washing machine or dishwasher bleach enhancer.

14. The detergent composition as in claim 1, wherein the composition contains an appropriate dosage of a descaling agent.

15. A process for manufacturing the detergent composition as in claim 1, comprising:
(a) manufacturing at least the first tablet type using a process in which substantially no pressure is applied;
(b) manufacturing at least the second tablet type using a process in which pressure is applied; and
(c) mixing at least the first and the second tablet type to form a mixture comprising various ingredients for a washing application.

16. The process according to claim 15, wherein the process in which substantially, no pressure is applied is a process selected from the group consisting of granulation, extrusion, casting and injection molding.

17. The process according to claim 15, wherein the process in which pressure is applied is a process selected from the group consisting of pressing and compacting.
